(19) United States
(12) Patent Application Publication
(10) Pub. No.: US 2017/0328387 A1
(43) Pub. Date: Nov. 16, 2017

(54) A CYLINDER WITH POSITION FEEDBACK SENSOR

(71) Applicant: Parker Hannifin Manufacturing Limited, Warwickshire (GB)

(72) Inventor: Marianne Viktoria PRYSSANDER, Vartofta (SE)

(21) Appl. No.: 15/529,234

(22) PCT Filed: Dec. 11, 2015
(86) PCT No.: PCT/GB2015/053809

§ 371 Date: May 24, 2017

(30) Foreign Application Priority Data
Dec. 15, 2014 (GB) 1422236.8

(51) Int. Cl. F15B 15/28; B62D 5/12

(52) U.S. Cl. CPC F15B 15/2846; B62D 5/12

(57) ABSTRACT

A cylinder with position feedback sensor, including a barrel (11), a piston rod (12) and piston (15). Markings (M) associated with a central portion of the piston rod (12C) are readable by a sensor (S). In practice, the freedom of slidable movement of the piston rod (12) is such that the markings are retained at all times entirely within the barrel (11) during use so that the external environment cannot influence (e.g. damage) the markings.

The present invention relates to a cylinder with a position feedback sensor developed in connection with hydraulic cylinders, particularly of the type used in steering cylinders in power steering systems for vehicles. However, features of the invention are also relevant to pneumatic cylinders and other industrial applications.

### BACKGROUND TO THE INVENTION

The basic principles of a hydraulic cylinder are well known in the prior art; for example, as illustrated by FIG. 1 of the attached drawings. Such a device includes a cylinder barrel main body B, with a piston rod P that is able to reciprocate in and out of the cylinder in reaction to fluid pressure on a piston head within the body (not illustrated). The fluid pressure is supplied via openings I and O respectively. A sensor S mounted at the distal end of the body is configured to read markings (M in FIG. 2) made on the outer surface of the piston rod P protruding from body B. An example of such a position sensor is known as the Intellinder™ Absolute Position Sensor (e.g. V4 series) supplied by Parker-Hannifin Corporation.

Position sensing of a piston rod P is critical in applications where precise location of the rod is required to be controlled, such as in steering applications (e.g. drive-by-wire or fly-by-wire). The Intellinder system achieves these precision goals, however, it is possible that the piston rod assembly and markings can be damaged, worn away or obscured by particulate which will affect position feedback capabilities, leading to reduced performance.

Other prior art examples with similar basic operation are found in US2013/0312601, WO00/77472 and WO2006/066161. These devices all feature a piston rod with markings for location control, however, as in prior art FIG. 1 such markings can be susceptible to damage or wear which affect operation.

### SUMMARY OF THE INVENTION

The present invention seeks to provide a cylinder assembly with a position feedback sensor that mitigates some of the problems identified with conventional designs where position feedback is desirable.

In one broad aspect of the invention there is provided a cylinder, e.g. a hydraulic cylinder, according to claim 1. Particularly, all of the markings made to a piston rod and/or piston for the purposes of position feedback are maintained within the cylinder barrel at all times during operation, i.e. even when at a maximal extension of the piston rod, the markings, or a substantive portion of the markings used for position feedback, are not exposed outside of the barrel/cylinder wall. A sensor mounted on or through the cylinder wall is then able to monitor/sense the required position feedback information from the piston rod for communication to a control system. Enclosing the piston rod carrying the markings entirely within a cylinder barrel provides protection from the external environment, e.g. dust/dirt/impact, and removes the requirement for load bearing materials to be in direct contact with the piston rod. Potentially a cylinder according to the invention also reduces system space requirements, complexity and component count while increasing steering angle potential.

The markings can be retained within the cylinder barrel by virtue of the extent/freedom of movement of the piston rod. In other words, in practice, movement of the piston rod is limited by a member abutting against the piston (ring or head) but this can take several different configurations still falling within the scope of the invention.

The general principles of the invention are applicable to many cylinder types and applications.

### BRIEF DESCRIPTION OF THE DRAWINGS

FIG. 1 illustrates a general view of a cylinder known in the prior art;

FIG. 2 illustrates a detailed view of circumferential markings on a piston rod as utilised by the Intellinder™ Absolute Position Sensor system known in the art;

FIG. 3 illustrates a cross section view of a cylinder according to the present invention;

FIG. 4 illustrates another section view of a similar cylinder where the piston rod is moved from its position shown in FIG. 3; and

FIGS. 5 and 6 illustrate plan and side views respectively of a hydraulic cylinder incorporating features of the present invention.

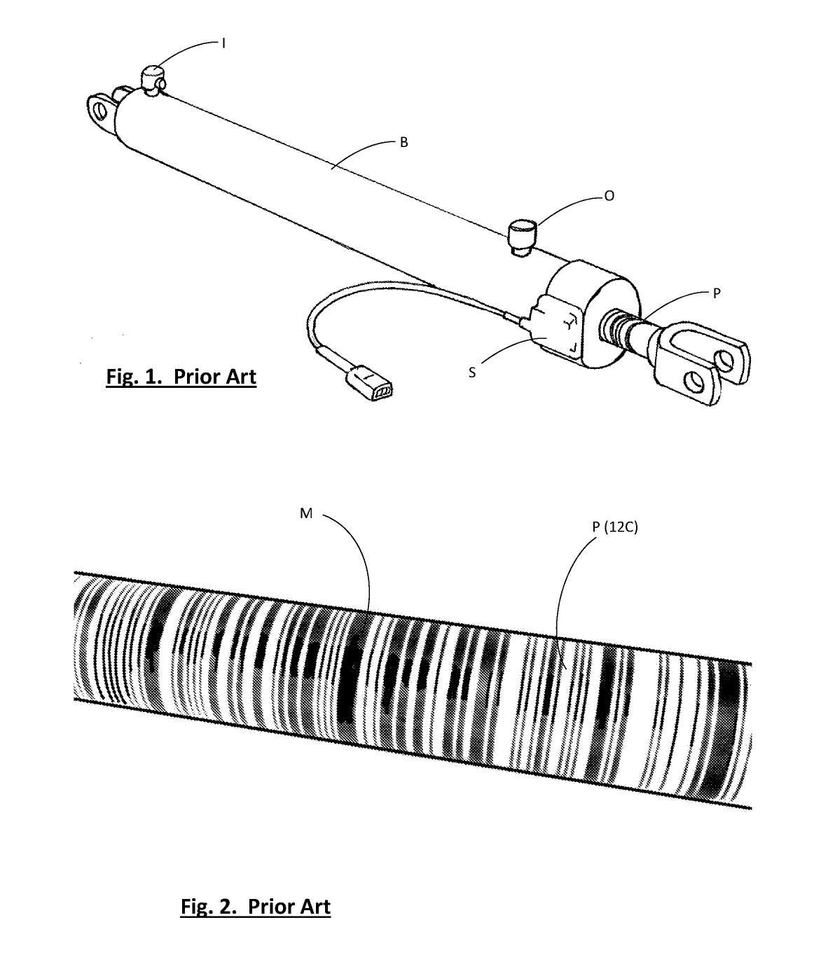

### DETAILED DESCRIPTION OF THE INVENTION

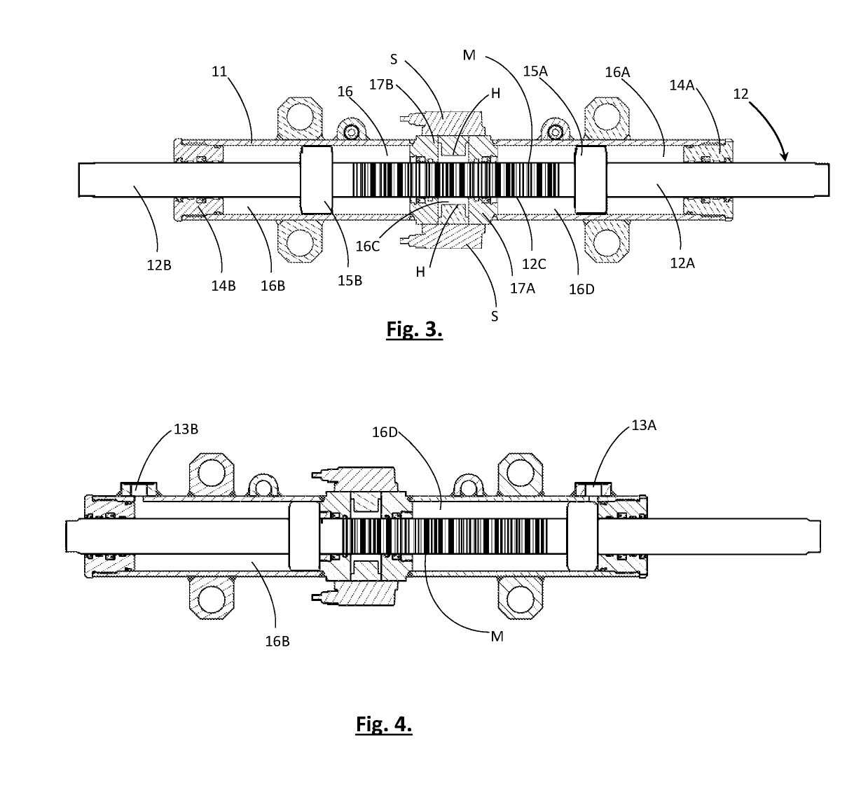

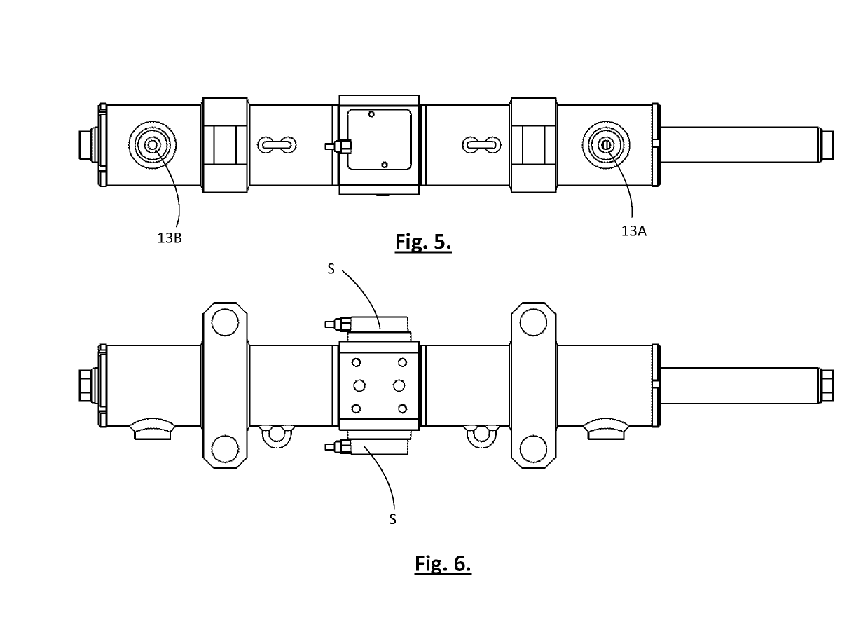

FIGS. 3 and 4 best illustrate the nature of the invention as applied to a hydraulic steering cylinder, although the invention should not be considered limited to only that type of cylinder. Such a cylinder includes a main cylinder barrel 11 which houses a piston rod assembly 12, mounted coaxially with the cylinder barrel 11 and able to move slidably relative thereto. Both ends of the piston rod 12A/12B protrude from a respective gland at the ends of the cylinder barrel 11 and would be coupled to further components which are actuated by virtue of hydraulic fluid being pumped into and out of the cylinder barrel, e.g. via inlet openings/ports 13A/13B shown in FIGS. 4, 5 and 6.

The general operation of a cylinder acted on by fluid pressure is well known and will not be explained in detail herein. Furthermore, the operating fluid of the cylinder is not limited by the invention, i.e. principles of the invention could be applied to both hydraulic and pneumatic cylinder systems.

Piston rod 12 is arranged for sliding movement by virtue of gland guide rings and seals 14A/14B which make cylinder barrel 11 oil tight to the external environment. Furthermore, pistons 15A/15B assist in locating piston rod 12 in its coaxial position while also providing a surface against which fluid directed into/out of the cylinder barrel 11 can act to cause movement of the piston rod 12. Barrel 11 is effectively divided into five chambers 16A, 16B, 16C, 16D and 16E by virtue of the multi-piston configuration illustrated.

It will be apparent that, according to FIG. 3, the piston rod is in a centred position where the respective chambers 16A and 16B, and 16D and 16E are relatively equal in volume. Fluid introduced to the two inside chambers, 16D and 16E (via porting not shown by FIG. 3), can be used to provide a hydraulic lock. Alternatively, fluid introduced to the two outermost chambers, 16A and 16B, would also provide a hydraulic lock.

By contrast, FIG. 4 illustrates a state where the piston rod 12 has moved to the right hand side by forcing fluid into chamber 16B (diminishing the volume of chamber 16E toward zero) and simultaneously evacuating chamber 16A in the known way, while chamber 16D increases toward a maximum volume. It will be apparent that a central portion 12C of piston rod 12 has moved relative to sensors S mounted on and through a wall of cylinder barrel 11.

In the illustrated embodiment a mid-barrel gland assembly 17A/17B, either side of the sensor position (effectively creating a fixed central chamber 16C), is provided to isolate the delicate optical sensing head H of sensor S from conditions within the barrel. As mentioned previously, sensor S is preferably of the Intellinder™ type supplied by Parker-Hannifin, but alternative systems may be available which are capable of monitoring a series of markings for the purposes of position feedback.

According to a preferred form of the invention, the centre portion 12C of piston rod 12 is provided with markings M that are intended to be monitored/read by sensor S for feedback of position information to a control means. The appearance of these markings (M) is likely to take the form as illustrated by FIG. 2, i.e. a “bar code” type structure, but alternative forms of marking are possible that do not depart from the scope of the present invention. At its heart, the present invention is concerned with maintaining the position feedback markings on the piston rod (and/or alternatively, in theory, the piston itself) entirely within the cylinder barrel so that these markings cannot be subject to any kind of damage or influence from the external environment.

In the illustrated form, the maximum “stroke” of the piston rod 12 relative to the barrel 11 is defined by the freedom of movement of a piston 15 (A & B) and where it can abut against either gland assembly 14 or a mid-barrel gland assembly 17. There may be alternative embodiments which control the freedom of movement of the piston/piston rod and achieve the advantage of the invention, namely a relatively central mounting position of sensor S that enables markings M on rod portion 12C to be retained entirely within the barrel, without the influence of external factors.

It may be possible to present a simplified form of cylinder where a single (e.g. extra wide) piston, that may have the markings thereon, is mounted on a rod extending from both ends. The widened piston markings would be in communication with the sensor.

Many components used in the cylinder of the invention, such as O-rings and the fluid delivery system are well known to those skilled in the art and have not been specified. Likewise, manufacturing techniques and materials for implementing the invention are well known in the art.

1. A cylinder including:
a barrel;
a piston rod extendable past at least one end of the barrel and arranged for slidable movement relative thereto;
a piston associated with the piston rod maintained within the barrel;
a first port through a wall of the barrel, located on a first side of the piston;
a second port through a wall of the barrel, located on a second side of the piston from the first port;
markings associated with a surface of the piston rod and/or piston;
a sensor, on or through a wall of the barrel, capable of sensing the markings for communication to a controller; wherein
freedom of slidable movement of the piston is such that the markings are retained entirely within the barrel at all times during use.

2. The cylinder of claim 1 wherein there are at least two pistons defining multiple chambers within the barrel.

3. The cylinder of claim 1 including an annular sensor gland associated with the sensor for isolating the sensor from actuating fluid within the barrel.

4. The cylinder of claim 3 wherein slidable movement of the piston in one direction is limited by said piston being able to abut against the annular sensor gland.

5. The cylinder of claim 1 wherein the sensor is located substantially at a middle portion of the barrel.

6. The cylinder of claim 1 wherein the markings are located at least on a central portion of the length of the piston rod.

7. The cylinder of claim 1 wherein the sensor is an optical sensor.

8. The cylinder of claim 1 wherein the piston rod extends past both ends of the barrel.

9. The cylinder of claim 8 wherein the barrel includes a first annular gland and a second annular gland, at respective distal ends of the barrel, that the piston rod is extendable therethrough.

10. The cylinder of claim 9 wherein slidable movement of the piston in one direction is limited by said piston being able to abut against the annular gland.

11. A method of constructing or modifying a cylinder for hydraulic or pneumatic use wherein a sensor device is attached to a midway portion of a side wall of the cylinder and markings are made on a portion of piston rod slidable within the cylinder at least coinciding with the midway portion of the side wall.

12. A power steering system incorporating a cylinder according to claim 1.

13. A vehicle incorporating a power steering system according to claim 12.
